(19) United States
(12) Patent Application Publication
(10) Pub. No.: US 2026/0133866 A1
(43) Pub. Date: May 14, 2026

(54) Validation of Memory Device Call-Tree Coherency

(71) Applicant: Silicon Laboratories Inc., Austin, TX (US)

(72) Inventors: Christian Galante, LaSalle (CA); Jean Francois Deschenes, Ste-Marthe-sur-le-lac (CA); Pablo Devanne, Saint Basile le Grand (CA)

(21) Appl. No.: 18/943,457

(22) Filed: Nov. 11, 2024

(51) Int. Cl. G06F 11/07

(52) U.S. Cl. CPC G06F 11/0772; G06F 11/073

(57) ABSTRACT

A system and method for validating that all functions within a time-critical task are resident in RAM is disclosed. This ensures that time-critical tasks are not impacted by having to access slow nonvolatile memory (NVM). The method comprises generating an exception for each transition between RAM-based instruction execution and NVM-based instruction execution, determining whether the transition is acceptable, and saving a fault address if the transition is not acceptable. A transition is deemed to be acceptable if it does not impact the execution of a time-critical function.

### FIELD

This disclosure describes systems and methods for validating that functions resident in slower memory are not executed by time-critical code.

### BACKGROUND

Many devices utilize processing units to perform their desired tasks. In certain situations, it may be imperative that a particular task be completed within a certain period of time. The code that stored these tasks may be referred to as time-critical tasks or time-critical functions.

Often, in these devices, there is a hierarchy of memory access. Cache typically has the shortest access time. Access time denotes that the time from when the processing unit indicates a need for a particular instruction or data to the time when that instruction or data is available to the processing unit. Random access memory (RAM) typically has the next shortest access time. Nonvolatile memories (NVMs), including FLASH, typically have slower access times. Thus, to guarantee that time-critical functions are executed within their required timeframe, the code for these time-critical functions is often resident in the RAM.

This optimization helps guarantee the performance requirements of the particular task. However, many times that time-critical task is made up of a plurality of functions. Ensuring that all of these functions are also resident in RAM is very tedious and error prone.

Therefore, a system and method of validating that all functions within a time-critical task are all resident in RAM would be beneficial.

### SUMMARY

A system and method for validating that all functions within a time-critical task are resident in RAM is disclosed. This ensures that time-critical tasks are not impacted by having to access slow nonvolatile memory (NVM). The method comprises generating an exception for each transition between RAM-based instruction execution and NVM-based instruction execution, determining whether the transition is acceptable, and saving a fault address if the transition is not acceptable. A transition is deemed to be acceptable if it does not impact the execution of a time-critical function.

According to one embodiment, a method to validate the call-tree coherency of a time-critical function is disclosed. The method comprises generating an exception every time there is a transition between RAM-based instruction execution and non-volatile memory (NVM)-based instruction execution; determining if the transition is acceptable; and recording a fault address if the transition is not acceptable. In some embodiments, a memory protection unit is used to generate the exception. In some embodiments, a transition from NVM-based instruction execution to RAM-based instruction execution is always acceptable. In some embodiments, for a transition from NVM-based instruction execution to RAM-based instruction execution, the method comprises saving a NVM-based return address. In certain embodiments, for a transition from RAM-based instruction execution to NVM-based instruction execution, the method comprises comparing a return address to a saved NVM-based return address. In certain embodiments, if the return address is different from the saved NVM-based return address, the fault address is recorded.

According to another embodiment, a method to validate the call-tree coherency of an interrupt handler is disclosed. The method comprises executing an enter hook when an interrupt is detected, wherein the enter hook creates a call-tree coherency context for an interrupt handler before it begins execution; executing the interrupt handler; and executing an exit hook to delete the call-tree coherency context after the interrupt handler has completed execution; wherein during execution of the interrupt handler, an exception is generated every time there is a transition between RAM-based instruction execution and non-volatile memory (NVM)-based instruction execution; wherein a fault address is recorded if the transition is not acceptable; and wherein the call-tree coherency context is used to determine whether the transition is acceptable. In some embodiments, an address of the interrupt handler is used by the enter hook to create the call-tree coherency context. In some embodiments, for a transition from NVM-based instruction execution to RAM-based instruction execution, the method comprises saving a NVM-based return address. In certain embodiments, for a transition from RAM-based instruction execution to NVM-based instruction execution, the method comprises comparing a return address to a saved NVM-based return address. In some embodiments, the NVM-based return address is part of the call-tree coherency context. In some embodiments, a memory protection unit (MPU) is used to generate the exception. In certain embodiments, the call-tree coherency context is used to determine a value to load into the MPU.

In some embodiments, the method comprises receiving a second interrupt having a higher priority while the interrupt handling is executing. In certain embodiments, after the second interrupt is received, the enter hook is executed a second time to create a second call-tree coherency context, which is stored in a stack on top of the call-tree coherency context. In certain embodiments, a second interrupt handler is executed after the enter hook is executed the second time, wherein during execution of the second interrupt handler, an exception is generated every time there is a transition between RAM-based instruction execution and NVM-based instruction execution; wherein a fault address is recorded if the transition is not acceptable; and wherein the second call-tree coherency context is used to determine whether the transition is acceptable. In certain embodiments, after completion of the second interrupt handler, the exit hook removes the second call-tree coherency context from the stack and returns control to the interrupt handler. In certain embodiments, a memory protection unit (MPU) is used to generate the exception, and the exit hook uses the call-tree coherency context to determine a value to load into the MPU before returning control to the interrupt handler.

### BRIEF DESCRIPTION OF THE DRAWINGS

For a better understanding of the present disclosure, reference is made to the accompanying drawings, in which like elements are referenced with like numerals, and in which:

FIG. 1 is a block diagram of a processing system;

FIG. 2 shows two examples of calls between RAM based functions and NVRAM based functions;

FIG. 3 shows the flow chart of the MPU exception handler;

FIG. 4 shows the flowchart for the enter hook; and

FIG. 5 shows the flowchart for the exit hook.

### DETAILED DESCRIPTION

This disclosure described a validation tool that may be used to identify the presence of NVM-based instructions in a time-critical task. This validation tool monitors transitions between RAM-based instruction execution and NVM-based instruction execution, and identifies possible issues. This validation tool is intended for use with a processing system that includes RAM and a smaller accessed non-volatile memory (NVM).

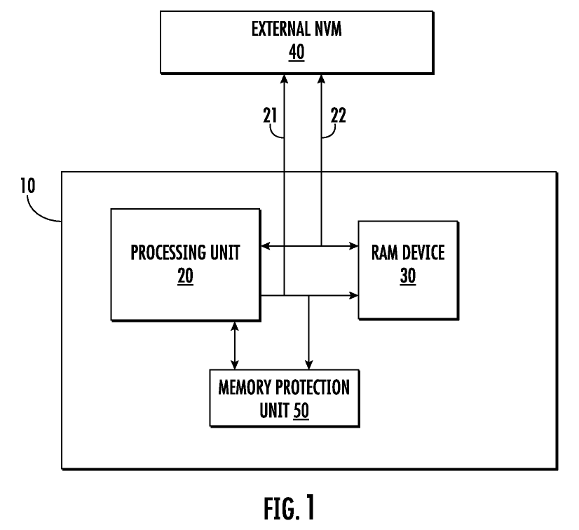

FIG. 1 shows a processing system 10. The processing system 10 includes a processing unit 20. This processing unit may be an ARM processor, such as a CORTEX-M processor. In other embodiments, the processing unit 20 may be a different processor, such as a RISC processor, a RISC-V processor, an ARM CORTX-A processor or others. The processing unit 20 may include an address bus 21 and a data bus 22. These two busses may connect to a memory device. The memory device is a volatile memory, such as a random access memory (RAM) 30. Further, this RAM 30 has a fast access time. In certain embodiments, the RAM 30 may be resident in the same semiconductor component as the processing unit 20. These busses are also used to access nonvolatile memory (NVM) 40. The NVM 40 may be an Electrical Erasable read only memory (EEROM), a ROM or a FLASH device. The access time of the NVM 40 is slower than that of the RAM 30. Further, in certain embodiments, the NVM 40 may be separate from the semiconductor component that includes the processing unit 20. In other words, the NVM 40 may be external to the processing unit 20, also referred to as off-chip. Additionally, in certain embodiments, to save external interconnects, the entire address bus 21 and data bus 22 may not be supplied to the NVM 40. In certain embodiments, the NVM 40 may connect to a serial bus, such as SPI, or to a narrower data bus. These optimizations further slow the access time to the NVM 40.

The processing unit 20 may also be in communication with a memory protection unit (MPU) 50. The MPU 50 is a circuit that is designed to monitor memory accesses and flag any accesses that are not authorized. The MPU 50 has, as inputs, the address bus 21. It also includes one or more registers that may be written by the processing unit 20 to set the desired attributes of a particular memory range. The MPU 50 also includes registers to hold the various address ranges, which may be defined as a starting address and a length, or as a starting address and an ending address. The MPU 50 also includes the ability to generate an exception to the processing unit 20 if it detects an access violation. Thus, the MPU 50 may be used to set attributes of a particular memory range. These attributes may include cacheable or noncacheable, access prohibited, read only, and/or execute never. The memory ranges may be defined using a starting address and a size.

When the MPU 50 detects an illegal operation, it triggers an exception. The exception handler associated with the MPU 50 may be used to detect when a time-critical function accesses a NVM address.

Specifically, if the code is currently executing from the RAM 30, an access to the NVM 40 may indicate that NVM-based instructions is being executed by the time-critical function. However, not all transitions from RAM-based instruction execution to NVM-based instruction execution are problematic.

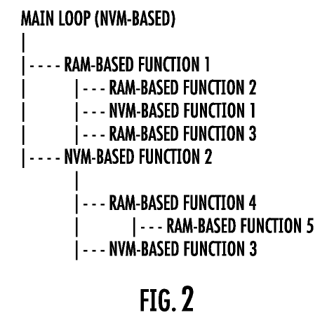

FIG. 2 shows an exemplary code segment. First, the main loop is resident in NVM 40. This main loop calls a RAM-based function 1. Note there is a transition from NVM-based instruction execution to RAM-based instruction execution when the RAM-based Function 1 is called. However, a transition to RAM-based instructions is always permissible. RAM-based Function 1 calls a second RAM-based Function 2. When the second RAM-based Function 2 completes, the RAM-based Function 1 calls NVM-based Function 1. This is not acceptable, as the original function was a RAM-based function and therefore is time-critical. The concept whereby a time-critical function only calls RAM-based functions is referred to herein as call-tree coherency. Note that the call to NVM-based Function 1 is not call-tree coherent, and therefore should be flagged. When the NVM-based Function 1 completes, the RAM-based Function 1 calls RAM-based Function 3. Note that the return of NVM-based Function 1 causes a transition from NVM-based instruction execution to RAM-based instruction execution. As noted above, this is always permissible.

After RAM-based Function 1 has completed, it returns back to the main loop. Note that the return of RAM-based Function 1 causes a transition from RAM-based instruction execution to NVM-based instruction execution. In this scenario, this is acceptable, since the main loop was not time-critical. The main loop then calls a NVM-based Function 2. The NVM-based Function 2 calls another RAM-based Function 4, which in turn calls another RAM-based Function 5. When RAM-based Function 4 returns, there is a transition from RAM-based instruction execution to NVM-based instruction execution in the main loop. However, since the RAM-based Function 4 was called by a NVM-based Function, this is an acceptable transition. The main loop then calls another NVM-based Function 3.

Thus, when transitions occur from RAM-based instruction execution to NVM-based instruction execution, it must be determined whether this transition occurs because a RAM-based function was returning back to a NVM-based function, or because the RAM-based function called the NVM-based function. Note that transition from NVM-based instruction execution to RAM-based instruction execution is always allowable.

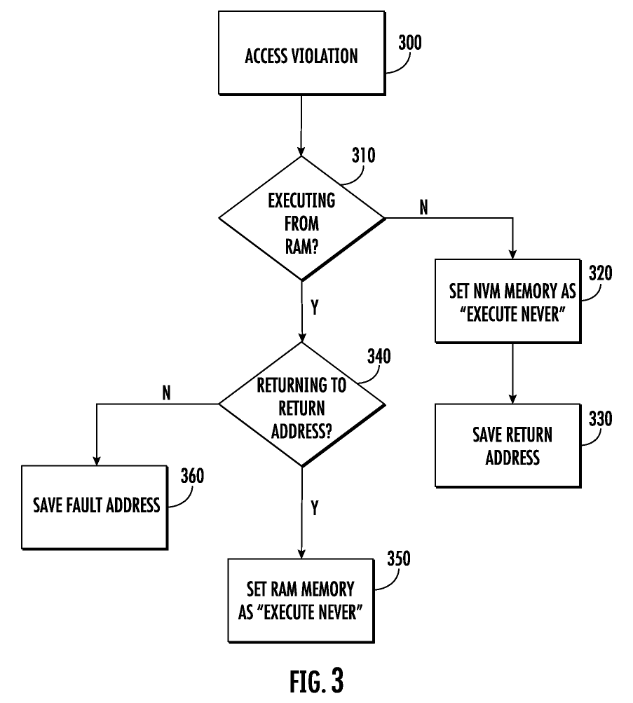

Thus, these concepts may be incorporated into the MPU exception handler. A flowchart of the MPU exception handler is shown in FIG. 3. First, the main loop may initialize the MPU. Since the main loop is resident in NVM 40, it will set up the MPU to indicate that any instructions executed from RAM 30 are prohibited. Thus, the MPU exception handler will be invoked when the first RAM-based instruction is executed. In FIG. 2, this will occur when RAM-based Function 1 is called by the main loop.

First, as shown in Box 300, an MPU exception is received. An MPU exception signifies that there is an access violation. An access violation occurs either when, after executing RAM-based instructions, a NVM-based instruction was encountered; or after executing NVM-based instructions, a RAM-based instruction was encountered. Therefore, in Decision Box 310, the MPU exception handler checks whether the function that caused this exception was previously executing from RAM. If it was not, then the function was previously executing from NVM 40 and the transition is to a RAM-based instruction, which is acceptable. Since instructions are now being fetched from RAM 30, the MPU will be set so that the NVM memory region has a status of “never execute”, as shown in Box 320. This means that if a NVM-based instruction is executed, an access violation will occur, invoking the MPU exception handler again. Finally, as shown in Box 330, the return address in NVM 40 is saved.

Returning to Decision Box 310, if, on the other hand, the function that caused this exception occurred when a function was previously executing from RAM, the MPU exception handler checks if the transition from RAM-based instruction to NVM-based instruction was the result of a return instruction, as shown in Decision Box 340. To do this, the MPU exception handler compares the current address to a previously saved return address (see Box 330). If these addresses match, then this is simply a RAM-based function returning back to the original NVM-based function. As code is being executed from NVM 40 again, the exception handler sets the RAM memory region to a status of “never execute”, as shown in Box 350. If, on the other hand, this was not the result of a RAM-based function returning back to a NVM-based function, an error has been detected, as shown in Box 360. In this case, the fault address may be saved so that the developer may review the error and correct the code to remove the call to the NVM-based function from the time-critical function. Alternatively, the developer may move this NVM-based function to RAM 30. Thus, Boxes 320 and 350 are used to ensure that an exception is generated for each transition between RAM-based instruction execution and NVM-based instruction execution. Additionally, Decision Boxes 310 and 340 are used to determine whether the transition was acceptable. In this disclosure, an acceptable transition is one which does not result in NVM-based instructions being executed in a time-critical function.

The operation of the MPU exception handler as the instructions shown in FIG. 2 are executed will be explained. As stated above, first, the MPU is initialized in the main loop up so that accesses to RAM 30 as set to “execute never”. Thus, when RAM-based function 1 is called, an access violation occurs, and the MPU exception handler is called. It executes the flowchart shown in FIG. 3 and updates the MPU 50 so that the NVM memory region is “execute never” and the return address of the main loop is saved. The instructions execute without any access violations until the RAM-based Function 1 calls the NVM-based function 1. At this time, the MPU exception handler detects that a NVM instruction has been fetched and determines that this is not the return address that was saved in Box 330 the last time the MPU exception handler was invoked. Thus, it records this address as a fault address. When the NVM-based Function 1 returns to the RAM-based Function 1, the MPU exception handler is invoked again, and changes the MPU so that NVM-based instructions are set to “execute never”. When RAM-based Function 3 returns to the main loop, the MPU exception handler is again invoked. In this situation, it is determined that this function is returning to the address that was previously saved in a previous invocation of the MU exception handler. Thus, no fault address is generated. This process repeats again when NVM-based Function 2 calls RAM-based Function 4 and when RAM-based function 4 returns to NVM-based Function 2. However, both of these transitions are acceptable and no fault addresses are saved.

In certain embodiments, each thread that executes in the main loop may be validated separately. Specifically, each thread may include a call-tree coherency context, which includes a saved return address (see Box 330 in FIG. 3), and the required state of the MPU 50. Note that in certain embodiments, these two pieces of information may be combined by using the value of the return address to determine the required state of the MPU 50. For example, if the return address is in NVM 40, then the MPU 50 is set so that NVM memory is “execute never”. If the return address is 0, then the MPU 50 is set so that RAM memory is “execute never”.

This call-tree coherency context is saved in the Thread Control Block (TCB). In this way, when a thread is to be executed, its entire context is typically restored from a Thread Control Block. Thus, the thread updates the MPU 50 based on the value found in its call-tree coherency context. When that thread is completed, its current call-tree coherency context is retained in its TCB. In certain embodiments, the MPU exception handler reads and writes the saved address directly from/into the TCB.

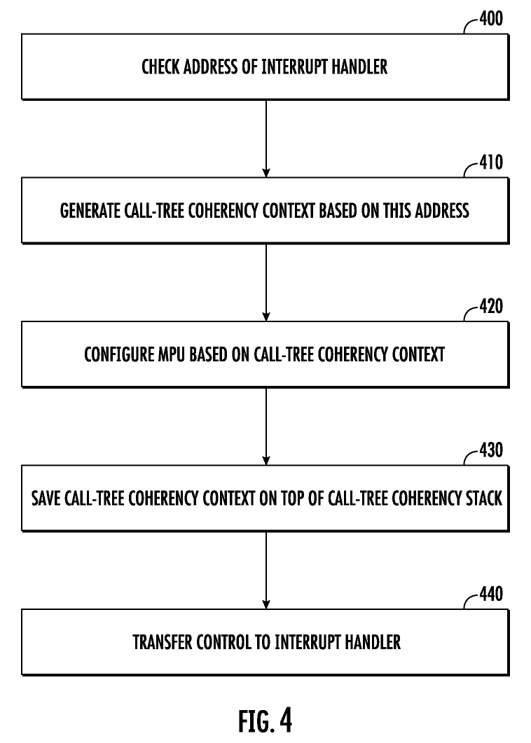

Similarly, in certain embodiments, in handler mode, each interrupt handler may also have its own call-tree coherency context. Specifically, whenever an interrupt occurs, for certain processors, an interrupt manager is invoked before passing control to the specific interrupt handler. This interrupt manager may include an enter hook and an exit hook. The enter hook is executed right before the specific interrupt handler is invoked, while the exit hook is executed immediately after the specific interrupt handler has completed its execution. FIG. 4 shows the operation of the enter hook.

First, the enter hook checks the address of the interrupt handler, as shown in Box 400. Based on the address of the interrupt handler, the enter hook generates the call-tree coherency context for this interrupt, as shown in Box 410. If the interrupt handler is located in RAM 30, the call-tree coherency context is set so that the MPU 50 is configured to treat the NVM 40 as “execute never”. The enter hook may also set the saved return address to an address that cannot be executed. If the interrupt handler is in NVM 40, the enter hook sets the return address as 0 and configures the MPU 50 so that RAM 30 is “execute never”. The enter hook may then configure the MPU based on this call-tree coherency context, as shown in Box 420. The enter hook then saves this call-tree coherency context on the top of a call-tree stack, as shown in Box 430. The enter hook then transfers control to the specific interrupt handler, as shown in Box 440. MPU exceptions may occur during the interrupt handler based on the configuration of the MPU 50, as described above. Further, the MPU exception handler may update the call-tree coherency context with a new return address, if necessary.

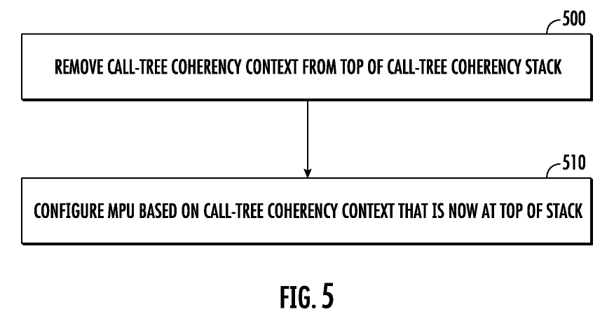

After the interrupt handler has completed execution, the exit hook in the interrupt manager is executed. Its execution is shown in FIG. 5. The exit hook first removes the call-tree coherency context from the top of the call-tree coherency stack, as shown in Box 500. The exit hook then examines the call-tree coherency context that is now on the top of the stack. Based on this, the exit hook then writes the appropriate value to the MPU 50, as shown in Box 510.

Note that if this interrupt is preempted by a higher priority interrupt, the enter hook is executed again. Thus, a new call-tree coherency context for the higher priority interrupt will be created and pushed onto the call-tree coherency stack by the enter hook. The higher priority interrupt will then execute using this new call-tree coherency context. When that higher priority interrupt completes, the exit hook will be executed. The exit hook will remove the call-tree coherency context for the higher priority interrupt from the call-tree coherency stack. Additionally, the exit hook will configure the MPU 50 based on the call-tree coherency context that is now on the top of the stack. In this way, the MPU is properly configured when control is returned to the original, lower priority interrupt. By including this stack of call-tree coherency contexts, nested interrupt handlers are supported.

Thus, the MPU exception handler, the enter hook and the exit hook in the interrupt manager, and the call-tree coherency context (which is located in the TCB and in a call-tree coherency stack) define a system that can be used to validate the call-tree coherency of each thread individually, as well as each interrupt handler, in a software image. The components of this system each comprise instructions which are stored in a non-transitory computer readable medium. These components are executed by the processing unit 20. Furthermore, this system is also able to validate the context of interrupt handlers, even when those interrupt handlers are nested.

The present system and method has many advantages. As noted above, when writing code, it is difficult to check whether every function that is called by a segment of time-critical code is resident in RAM. This validation tool simplifies this process significantly by automatically detecting every transition between RAM-based instructions and NVM-based instructions. This tool allows developers to quickly identify potential issues by executing the code in a real world environment. The amount of overhead associated with this validation tool is relatively small, which keeps its impact on performance small.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method to validate call-tree coherency of a time-critical function, comprising:
generating an exception every time there is a transition between RAM-based instruction execution and non-volatile memory (NVM)-based instruction execution;
determining if the transition is acceptable; and
recording a fault address if the transition is not acceptable.

2. The method of claim 1, wherein a memory protection unit is used to generate the exception.

3. The method of claim 1, wherein a transition from NVM-based instruction execution to RAM-based instruction execution is always acceptable.

4. The method of claim 1, wherein for a transition from NVM-based instruction execution to RAM-based instruction execution, the method comprises saving a NVM-based return address.

5. The method of claim 4, wherein for a transition from RAM-based instruction execution to NVM-based instruction execution, the method comprises comparing a return address to a saved NVM-based return address.

6. The method of claim 5, wherein if the return address is different from the saved NVM-based return address, the fault address is recorded.

7. A method to validate call-tree coherency of an interrupt handler, comprising:
executing an enter hook when an interrupt is detected, wherein the enter hook creates a call-tree coherency context for an interrupt handler before it begins execution;
executing the interrupt handler; and
executing an exit hook to delete the call-tree coherency context after the interrupt handler has completed execution;
wherein during execution of the interrupt handler, an exception is generated every time there is a transition between RAM-based instruction execution and non-volatile memory (NVM)-based instruction execution; wherein a fault address is recorded if the transition is not acceptable; and wherein the call-tree coherency context is used to determine whether the transition is acceptable.

8. The method of claim 7, wherein an address of the interrupt handler is used by the enter hook to create the call-tree coherency context.

9. The method of claim 7, wherein for a transition from NVM-based instruction execution to RAM-based instruction execution, the method comprises saving a NVM-based return address.

10. The method of claim 9, wherein for a transition from RAM-based instruction execution to NVM-based instruction execution, the method comprises comparing a return address to a saved NVM-based return address.

11. The method of claim 10, wherein if the return address is different from the saved NVM-based return address, the fault address is recorded.

12. The method of claim 9, wherein the NVM-based return address is part of the call-tree coherency context.

13. The method of claim 7, wherein a memory protection unit (MPU) is used to generate the exception.

14. The method of claim 13, wherein the call-tree coherency context is used to determine a value to load into the MPU.

15. The method of claim 7, further comprising receiving a second interrupt having a higher priority while the interrupt handling is executing.

16. The method of claim 15, wherein after the second interrupt is received, the enter hook is executed a second time to create a second call-tree coherency context, which is stored in a stack on top of the call-tree coherency context.

17. The method of claim 16, wherein a second interrupt handler is executed after the enter hook is executed the second time, wherein during execution of the second interrupt handler, an exception is generated every time there is a transition between RAM-based instruction execution and NVM-based instruction execution; wherein a fault address is recorded if the transition is not acceptable; and wherein the second call-tree coherency context is used to determine whether the transition is acceptable.

18. The method of claim 17, wherein after completion of the second interrupt handler, the exit hook removes the second call-tree coherency context from the stack and returns control to the interrupt handler.

19. The method of claim 18, wherein a memory protection unit (MPU) is used to generate the exception, and the exit hook uses the call-tree coherency context to determine a value to load into the MPU before returning control to the interrupt handler.
